(19) United States
(12) Patent Application Publication
(10) Pub. No.: US 2015/0033944 A1
(43) Pub. Date: Feb. 5, 2015

(54) METHOD AND ARRANGEMENT FOR WASTE-GAS PURIFICATION IN VACUUM STEEL TREATMENT PROCESSES

(71) Applicants: Michael Luven, Kempen (DE); Johannes Obitz, Kerken (DE); Arno Luven, Krefeld (DE)

(72) Inventors: Michael Luven, Kempen (DE); Johannes Obitz, Kerken (DE); Arno Luven, Krefeld (DE)

(21) Appl. No.: 14/373,643

(22) PCT Filed: Jan. 23, 2013
(86) PCT No.: PCT/EP2013/051224

§ 371 Date: Jul. 22, 2014

(30) Foreign Application Priority Data
Jan. 24, 2012 (AT) A 71/2012

(51) Int. Cl. B04C 9/00; B01D 46/42; B01D 50/00; B01D 45/12

(52) U.S. Cl. CPC B04C 9/00; B01D 45/12; B01D 46/4263; B01D 50/002; B04C 2009/004
USPC 95/268; 55/315.1; 55/302

(57) ABSTRACT

A method for waste gas purification in dust separation plants making use of a device (16) for generating a negative pressure, in particular by means of steam jet ejector pumps or mechanical vacuum pumps, wherein the waste gas coming from a vacuum chamber (15) is conducted into a cyclone separator (12), and that the method steps of coarse separation of particles from the waste gas and fine dust separation of particles from the waste gas and gas cooling in the cyclone separator (12) are carried out in succession in such a way that the waste gas, after coarse purification has taken place, is conducted directly via a fine dust filter (13) installed in the cyclone separator (12) and subsequently through a gas cooler (14), which follows the fine dust filter (13), into a suction line (2) connected to the device (16) for generating a negative pressure and to the device (16).

### PRIOR ART

Molten steel is treated under vacuum in the so-called secondary metallurgical processes in steel production, in particular in oxygen blowing processes. The so-called steel degassing and the production of steels with a low C content by so-called top-blowing of oxygen are treatment variants which are known from the prior art and find worldwide application.

The plants for performing the aforementioned method essentially comprise two core components, the so-called vacuum chamber on the one hand, in which foundry ladles with molten steel with a capacity of up to over 300 t are treated under vacuum, and on the other hand the vacuum generator, which is connected via a suction line to the vacuum chamber. In the case of the processes taking place under reduced pressure between 200 mbar and 0.6 mbar absolute, dissolved gases and reaction gases are liberated, which are drawn off by suction from the vacuum generator, whilst maintaining the given absolute working pressure. Entrained metallic and non-metallic dust particles or those arising due to evaporation and condensation are also transported in the waste gas flow. Depending on the process, the dust, with a waste gas temperature of up to 500° C. and a grain size of 0.5 μm to ≧100 μm, can amount to an accumulation by mass of 3 kg to 4 kg dust per tonne of molten steel.

Two different types of vacuum pump systems are used nowadays for high suction volumes at low suction pressure: on the one hand there are the steam jet ejector pumps for the most part insensitive to dust, which have a higher energy requirement, and on the other hand there are the dust-sensitive mechanical vacuum pumps.

In plants in which the vacuum is generated by means of multistage steam jet ejector pumps, the dust load in the waste gas does not represent a direct functional impairment of the ejector pumps. The waste gases are compressed to atmospheric pressure here via multistage ejectors, wherein up to approx. 5% to 10% of the dusts contained in the waste gases is deposited at the walls of the pipelines and ejectors and the remaining 90% to 95% is washed out and carried out by the circuit cooling water into the injection condensers. High outlay on labour-intensive manual cleaning work and on the cleaning of the circuit water contaminated by the dust particles is however considered a drawback here. The vacuum generation by the steam jets, moreover, is further characterised by a high steam consumption, which has to be generated on site in a high-performance steam generator, which gives rise to additional costs.

The operation of mechanical vacuum pumps, which however are sensitive to high temperatures and the dust in the gas sucked in, is on the other hand much more energy-saving. Gas/dust separation and gas cooling between the vacuum chamber and the vacuum pump is therefore always provided in principle for mechanical vacuum pumps. In previously installed plants employing mechanical vacuum pumps, the sucked-in gas is first conveyed through a cyclone before entry into the vacuum pumps, in which cyclone the separation of coarse dust particles takes place. The gas is then conveyed for cooling into a gas cooler and passes from there through a fine dust filter, which is used to separate or segregate the smallest dust particles.

The aforementioned components of a device employing mechanical vacuum pumps are installed one after the other in the vacuum line, which apart from the space requirement leads to a corresponding length of the vacuum line. This is contrary to the requirement for a line as short as possible between the vacuum chamber and the vacuum pump set, in order to achieve maximum efficiency with the vacuum generation in the vacuum chamber.

### SUMMARY OF THE INVENTION

The problem of the invention is to prevent for the most part the described problems with the use both of steam jet ejector pumps and with mechanical vacuum pumps. This problem is solved with a method having the features disclosed herein.

The core idea of the invention consists in the fact that all the required method steps for the dust separation such as the preliminary dust separation, the fine filtering and the gas cooling are to be carried out in a single, vacuum-tight compact cyclone separator with an installed fine dust filter with a connected gas cooler, wherein the untreated gas entering into the cyclone is forced into a rotary motion by helicoidal baffle plates, as a result of which the coarse dust separation on the one hand is promoted, and on the other hand preliminary cooling of the gas flow is brought about at the outer jacket of the installed heat exchanger. The gas is then conveyed through a fine dust filter equipped with a stainless steel microfilter mat and the connected water-cooled gas cooler and via the gas funnel into the vacuum gas line to the vacuum pumps. It is very particularly advantageous here that, as a result of the compact design of the device, the length of the vacuum line is shortened considerably, as a result of which the pressure loss can be kept low.

Advantageous developments are also stated herein.

The assembled filter/cooling unit is supported loosely on the waste gas funnel of the device, so that the components can easily be removed upwards out of the housing of the device, since the latter merely have to be lifted up.

At the lower funnel-shaped end, the cyclone comprises a vacuum-tight dust cap, via which the occurring coarse and fine dust can be removed.

The fine filter is cleaned pneumatically by means of inert gas. Independently of this, separate flooding of the cyclone interior by means of inert gas is advantageous.

### BRIEF DESCRIPTION OF THE DRAWINGS

Further advantages, features and details of the invention will emerge from the following description of a preferred example of embodiment of the invention and on the basis of the drawing. In the figures:

FIG. 1 shows an arrangement for waste gas purification according to the prior art in a schematic representation,

FIG. 2 shows an arrangement according to the invention for waste gas purification, also in a schematic representation, and

FIG. 3 shows a cyclone separator used in the arrangement according to FIG. 2 in a longitudinal cross-section.

### DETAILED DESCRIPTION

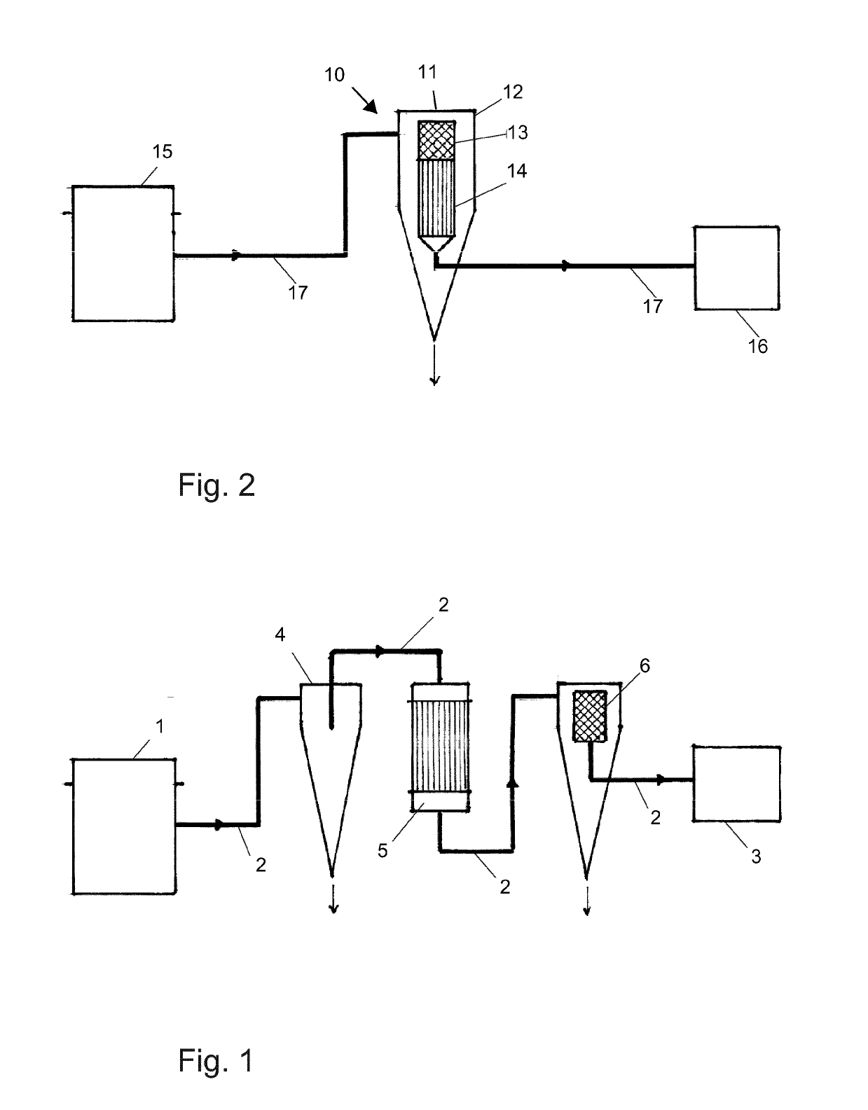

FIG. 1 shows a device corresponding to the present prior art for waste gas purification in steel production with a cyclone separator 4 for coarse dust separation installed in a suction line 2 between a vacuum chamber 1 and a vacuum generator 3, a separately disposed gas cooler 5 and a following fine filter 6. Fine filter 6 is disposed here after gas cooler 5, since the former are frequently provided with cloth filter bags which have to be protected against high gas temperatures.

FIG. 2 shows an arrangement 10 according to the invention for waste gas dust separation with a fine dust filter 13 integrated in cyclone housing 11 of a cyclone separator 12 and a gas cooler 14. Cyclone separator 12 is disposed between a vacuum chamber 15 and a vacuum generator 16 in a vacuum line 17, wherein vacuum generator 16 can be of any design.

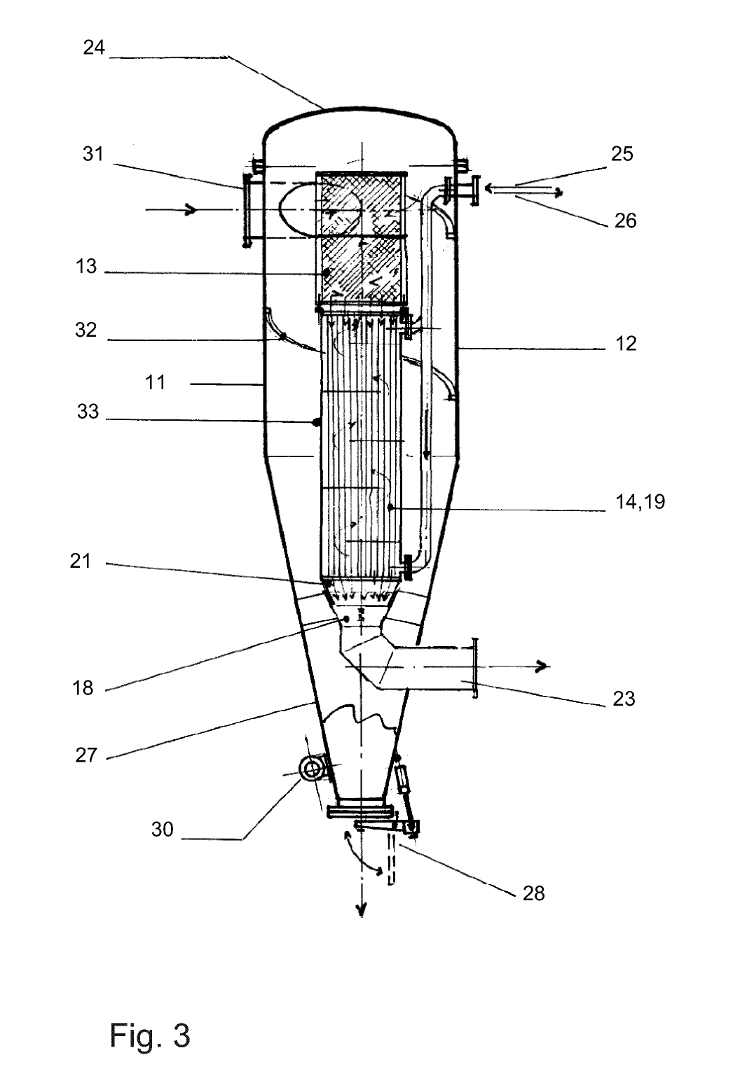

FIG. 3 shows the detailed structure of a cyclone separator 12 according to the invention with installed fine dust filter 13 and gas cooler 14.

The apparatus unit comprises cyclone housing 11 for the preliminary dust separation, gas cooler 14, which is constituted as a water-cooled tube bundle heat exchanger 19, and fine dust filter 13 for the fine filtering of the waste gas.

Fine dust filter 13 and tube bundle heat exchanger 19 are connected to one another and are disposed concentrically in vacuum-tight cyclone housing 11, in such a way that lower part 21 of tube bundle heat exchanger 19 is constituted conical and sits loosely in conical counter-funnel 18 of gas outlet connecting piece 23 of cyclone housing 11. Easy dismantling for maintenance purposes is thus guaranteed after the opening of cover 24 of cyclone housing 11 and after detachment of water inlet and outlet connections 25 and 26. Depending on the requirement, fine dust filter 13 can also be dismantled without gas cooler 14 and tube bundle heat exchanger 19.

A vacuum-tight closure cap 28, preferably with a pneumatic or hydraulic drive, is installed on lower cyclone cone 27 for the dust removal. To assist the dust removal from cyclone separator 12, an agitator 30 with an electric or pneumatic drive is fitted, which is preferably located on cyclone cone 27.

The function of cyclone separator 12 is as follows: the dust-laden hot gas is conveyed by the suction force of vacuum generator 16 into tangentially disposed inlet connecting piece 31 of cyclone separator 12. As a result of the high entry speed and the rotary motion thus occurring, the centrifugal forces act on the larger particles of the hot gas, so that the particles are captured in a known manner in cyclone cone 27. Helicoidally shaped baffle plates 32 at the inner wall of cyclone housing 11 assist the process of separating the particles. As a result of the gas flow initially directed vertically, partial cooling of the gas is already achieved by water-cooled jacket 33 of tube bundle heat exchanger 19.

The total gas volume with the residual dusts is sucked via a fine dust filter 13 and then through tube bundle heat exchanger 19. Fine dust filter 13 preferably comprises close-mesh stainless steel microfilter mats and is adapted to the fine-grained particle size. For the cleaning of fine dust filter 13, pneumatic impulse bursts, preferably by means of inert gas, from the interior of fine dust filter 13 in the direction of cyclone housing 11 are provided during plant downtimes, said impulse bursts conveying the dust downwards into cyclone cone 27.

Water-cooled tube bundle heat exchanger 19 is constituted according to the counter-current principle—gas through the tubes, water around the tubes. The cooled purified gas which has contracted in volume leaves cyclone separator 12 in the direction of vacuum generator 16 through gas outlet connecting piece 23. Depending on the dust grain size distribution, provision can be made to rotate fine dust filter 13 and gas cooler 14 in cyclone housing 18 through 180°.

The flooding of the entire system usually takes place with atmospheric air at the end of the process. On account of an O₂ enrichment at the grain surface, the high fine grain proportion can lead to spontaneous ignition or, interlinked with other operating states, e.g. ignition sparks with sufficient capacitance, to explosion. At the end of the process, therefore, the interior of cyclone separator 12 is preferably separated from the remaining volume of the plant and flooded with inert gas.

1. A method for waste gas purification in dust separation plants making use of a device (16) for generating a negative pressure, in particular by means of steam jet ejector pumps or mechanical vacuum pumps,
wherein waste gas coming from a vacuum chamber (15) is conducted into a cyclone separator (12), and wherein the method steps of coarse separation of particles from the waste gas and fine dust separation of particles from the waste gas and gas cooling in the cyclone separator (12) are carried out in succession in such a way that the waste gas, after coarse purification has taken place, is conducted directly via a fine dust filter (13) installed in the cyclone separator (12) and subsequently through a gas cooler (14), which follows the fine dust filter (13), into a suction line (2) connected to the device (16) for generating a negative pressure and to the device (16).

2. The method according to claim 1, wherein coarse particles are separated from the waste gas entering into the cyclone separator (12) by a helicoidal motion brought about by baffle plates (32), and that, for preliminary cooling, the waste gas flows around an outer wall (33) of the gas cooler (14) constituted as a heat exchanger (19).

3. An arrangement (10) for performing the method according to claim 1, wherein the arrangement (10) comprises a cyclone separator (12) with a cyclone housing (11), wherein a fine dust filter (13) and a gas cooler (14) are disposed in the cyclone housing (11), and wherein waste gas entering into the cyclone separator (12) can be conveyed forcibly via the fine dust filter (13) and the gas cooler (14) to a suction line (2) connected to the device (16).

4. The arrangement according to claim 3, wherein the fine dust filter (13) comprises a gas outlet connecting piece (23) projecting out of the cyclone housing (11), and wherein the cyclone housing (11) comprises a removal device in the form of a closure cap (28) for particles.

5. The arrangement according to claim 4, wherein the closure cap (28) is disposed at the base of a cone-shaped region (17) of the cyclone housing (11), and wherein the region (17) is coupled with an agitator device (30) for loosening particles in the cyclone housing (11).

6. The arrangement according to claim 3, wherein at least one helicoidal baffle plate (32) for conducting the waste gas is fitted in the cyclone housing (11).

7. The arrangement according to claim 6, wherein the at least one baffle plate (32) conducts the waste gas onto the outer wall (33) of the gas cooler (13).

8. The arrangement according to claim 3, wherein the fine dust filter (13) installed in the cyclone housing (11) and the gas cooler (14) are connected to one another and sit loosely on a housing section (18) of the gas outlet connecting piece (23).

9. The arrangement according to claim 3, wherein the fine dust filter (13) comprises stainless steel microfilter mats and is equipped for pneumatic cleaning by means of inert gas.

10. The arrangement according to claim 4, wherein the dust cap (13) of the cyclone housing (11) is sealed vacuum-tight.
